(19) United States
(12) Patent Application Publication
(10) Pub. No.: US 2024/0377805 A1
(43) Pub. Date: Nov. 14, 2024

(54) CLOSED-LOOP CONTROLLER STRUCTURE FOR MIXED DIRECT/INDIRECT DRIVE OF A MACHINE ELEMENT

(71) Applicant: Siemens Aktiengesellschaft, 80333 München (DE)

(72) Inventors: David Bitterolf, Erlangen (DE); Sven Tauchmann, Chemnitz (DE); Stephan Hansen, Stade (DE); Tobias Hamann, Stade (DE)

(73) Assignee: Siemens Aktiengesellschaft, 80333 München (DE)

(21) Appl. No.: 18/659,405

(22) Filed: May 9, 2024

(30) Foreign Application Priority Data
May 10, 2023 (EP) 23172628.2

(51) Int. Cl. G05B 19/404; G05B 19/416

(52) U.S. Cl. CPC G05B 19/404; G05B 19/416; G05B 2219/42083

(57) ABSTRACT

A first drive acts on a machine element via a transmission and a second drive acts on the machine element directly. First and second closed-loop speed controllers determine respective first and second setpoint force values for the first and second drives with the aid of the difference between the setpoint speed value and of the actual speed value and activate the first drive and/or the second drive as a function of the respective first and second setpoint force values. Respective first and second pilot force values are determined from a first axis inertia scaled by a first scaling factor (α), and second axis inertia scaled by a second scaling factor (1−α).

### CROSS-REFERENCES TO RELATED APPLICATIONS

This application claims the priority of European Patent Application, Serial No. 23172628.2 of May 10, 2023, pursuant to 35 U.S.C. 119(a)-(d), the content of which is incorporated herein by reference in its entirety as if fully set forth herein.

### BACKGROUND OF THE INVENTION

The present invention relates to a closed-loop controller structure for a first and a second drive, wherein the first drive acts on a machine element via a transmission facility and the second drive acts directly on the machine element for movement of the machine element in relation to an axis, wherein the closed-loop control of the first drive is undertaken by means of a first pilot force control value and the closed-loop control of the second drive is undertaken by means of a second pilot force control value.

The present invention is based in particular on a closed-loop controller structure for a first and a second drive, wherein the first drive wherein the first drive acts on a machine element via a transmission facility and the second drive acts directly on the machine element for movement of the machine element,
wherein the closed-loop controller structure has a closed-loop position controller, which, with a closed-loop position control clock pulse, accepts a setpoint position value and an actual position value of the machine element and activates the first drive as a function of the respective setpoint position value and the respective actual position value,
wherein the closed-loop controller structure comprises a second closed-loop speed controller, which with a second closed-loop speed control clock pulse accepts the difference between a resulting setpoint speed value and an actual speed value of the machine element, with the aid of the respective resulting setpoint speed value and the respective actual speed value of the machine element, determines a second setpoint force value for the second drive determines and activates the second drive as a function of the respective second setpoint force value,
wherein the closed-loop controller structure has a first determination facility, which determines the respective resulting setpoint speed value and outputs it to the first closed-loop speed controller,
wherein the closed-loop position controller, with the aid of the difference between the respective setpoint position value and the respective actual position value, determines a setpoint speed value for the machine element in each case and outputs the respective setpoint speed value as an output signal,
wherein the closed-loop controller structure comprises a first closed-loop speed controller, which with a first closed-loop speed control clock pulse accepts the difference between the resulting setpoint speed value and an actual speed value of the first drive in each case, determines, with the aid of the difference between the respective resulting setpoint speed value and the respective actual speed value of the first drive, a first setpoint force value for the first drive in each case and activates the first drive as a function of the respective first setpoint force value,
wherein the first determination facility accepts the respective setpoint speed value and, using the respective setpoint speed value, determines the resulting setpoint speed value,
wherein the first determination facility additionally also outputs the respective resulting setpoint speed value to the first closed-loop speed controller to the second closed-loop speed controller.

The present invention is furthermore based on an open-loop control facility for a first and a second drive, wherein the first drive acts on a machine element via a transmission facility and the second drive acts directly on the machine element,
wherein the open-loop control facility has a higher-ranking controller and a closed-loop controller structure,
wherein the higher-ranking controller of the closed-loop controller structure specifies setpoint position values with a closed-loop position control clock pulse,
wherein the closed-loop controller structure is embodied in the way described above.

The present invention is furthermore based on a machine,
wherein the machine has a machine element, a first drive, a second drive and a transmission facility,
wherein the first drive acts via the transmission facility on the machine element and the second drive acts directly on the machine element,
wherein the first drive and the second drive are controlled by such an open-loop control facility.

The present invention is further based on a method for closed-loop control of a drive unit with a first and a second drive, wherein the first drive acts on a machine element via a transmission facility and the second drive acts directly on the machine element for movement of the machine element in relation to an axis, wherein the closed-loop control of the first drive is undertaken by means of a first pilot force value and the closed-loop control of the second drive is undertaken by means of a second pilot force value.

The present invention is in particular based on a method for closed-loop control of a drive unit with a first and a second drive, wherein the first drive acts on a machine element via a transmission facility and the second drive acts directly on the machine element for movement of the machine element in relation to an axis,
wherein a closed-loop position controller with a closed-loop control clock pulse accepts the difference between a setpoint position value and an actual position value of the machine element in each case and activates the first drive as a function of the respective setpoint position value and the respective actual position value in each case,
wherein a second closed-loop speed controller accepts the difference between a resulting setpoint speed value and an actual speed value of the machine element in each case with a second closed-loop speed control clock pulse, with the aid of the respective resulting setpoint speed value and the respective actual speed value of the machine element, determines a second setpoint force value for the second drive in each case and activates the second drive as a function of the respective second setpoint force value,
wherein a first determination facility determines the respective resulting setpoint speed value and outputs it to the first closed-loop speed controller,
wherein the closed-loop position controller, with the aid of the difference between the respective setpoint position value and the respective actual position value, determines a setpoint speed value for the machine element in each case and outputs the respective setpoint speed value as an output signal,
wherein a first closed-loop speed controller accepts the difference between the resulting setpoint speed value and an actual speed value of the first drive with a first closed-loop speed control clock pulse in each case, determines with the aid of the difference between the respective resulting setpoint speed value and the respective actual speed value of the first drive, a first setpoint force value for the first drive and activates the first drive as a function of the respective first setpoint force value,
wherein the first determination facility accepts the respective setpoint speed value and, using the respective setpoint speed value, determines the resulting setpoint speed value,
wherein the first determination facility also outputs the respective resulting setpoint speed value, in addition to the first closed-loop speed controller, to the second closed-loop speed controller.

Machine axes as a rule consist of a drive, a transmission facility and a machine element. The drive acts in this case via the transmission facility on the machine element. The disadvantage of this arrangement is that the transmission facility has a relatively low rigidity and therefore at least the dynamics, in many cases also the positioning accuracy of the machine element, are relatively low.

In particular machine axes in which the drive system comprises a servo motor with a classical drive train (KGT, gearing etc.) and at the same time a direct drive are addressed by this invention. Such a drive arrangement is differentiated from the classical master-slave arrangement with symmetrical drive trains in that the setpoint force value is not divided up strictly proportionally, but according to task.

This arrangement offers the advantage of being able to combine the merits of both types of drive (direct and indirect).
The direct drive is close to the load and can be used for the transmission of high-frequency proportions of the force. The direct drive close to the load can be used for the damping of process-related forms of vibration.
The high level of transmission enables the “favorably” designed servo motor to compensate, with little mounting space and force, for high static and quasi-static loads.

The object of this drive constellation is to increase the axis dynamics. In such cases it should be possible,
with the quality remaining the same, to move with a greater jerk and/or a higher acceleration and thus to increase productivity,
or, with dynamics remaining the same, to reduce the tendency to vibrate and thus to increase the quality of the movement,
or to increase the quality/path accuracy while at the same increasing the dynamics.

In a design to be frequently encountered, an axis driven indirectly, via for example a ball bearing spindle or a transmission is supplemented by a direct drive on the load side. With linear axes a linear motor is employed as well, with round axes (axes of rotation) a torque motor is employed.

The problem of this mixture of drives is primarily the complexity of the integration of the direct drive due to the size of the motor and the complicated cooling. Furthermore the costs for the direct drive are very high by comparison with the indirect drive. If this approach is chosen for example for the three main axes of a robot, significant additional costs arise, which restricts the system in its competitiveness despite the increase in the dynamics.

It is an object of the present invention is to create a closed-loop controller structure for an axis with a number of drives, which allows the drives to be dimensioned in a cost-optimized manner.

### SUMMARY OF THE INVENTION

According to one aspect of the present invention, a closed-loop controller structure of the type includes in addition to a prior art a closed-loop controller structure for a first and a second drive described in the introduction, wherein the first drive wherein the first drive acts on a machine element via a transmission facility and the second drive acts directly on the machine element for movement of the machine element, a third determination facility, which comprises the first inertia determination facility, which determines a first axis inertia, wherein the third determination facility comprises a second inertia determination facility, which determines a second axis inertia determines and wherein the first axis inertia and/or the second axis inertia, each enter in a different, especially adjustable, weighting into the determination of the first pilot force value and of the second pilot force value.

In accordance with the invention a closed-loop controller structure of the type mentioned in the introduction is especially embodied in that
the closed-loop controller structure has a third determination facility, which with a pilot control clock pulse accepts an acceleration pilot control value in each case, with the aid of the respective acceleration pilot control value, determines a respective second pilot force value for the second drive and outputs the respective second pilot force value to a second addition facility, which adds the respective second pilot force value to the respective second setpoint force value, so that the second drive is activated according to the sum of the respective second pilot force value and of the respective second setpoint force value,
wherein the third determination facility, with the aid of the respective provisional pilot force value, determines a respective first pilot force value for the first drive and outputs the respective first pilot force value to a first addition facility, which adds the respective first pilot force value to the respective first setpoint force value, so that the first drive is activated according to the sum of the respective first pilot force value and of the respective first setpoint force value,
wherein the third determination facility comprises a first inertia determination facility, which determines a first axis inertia, wherein the third determination facility comprises a second inertia determination facility, which determines a second axis inertia,
wherein the respective first pilot force value is determined with the aid of the motor inertia, the first axis inertia, the second axis inertia and a first scaling factor and
wherein the respective second pilot force value is determined with the aid of the second axis inertia and a second scaling factor.

What can be achieved in particular by the determination of the resulting setpoint speed value as a function of both the setpoint position value and also the actual position value—in particular as a function of the difference between setpoint position value and actual position value—is that the first drive, even for faults that do not make themselves apparent in the setpoint position value, supports the correction of these types of faults with high dynamics.

The invention makes provision for the closed-loop controller structure to have a third determination facility, which accepts an acceleration pilot control value with a pilot control clock pulse in each case, with the aid of the respective acceleration pilot control value, determines a respective second pilot force value for the second drive and outputs the respective second pilot force value to a second addition facility, which adds the respective second pilot force value to the respective second setpoint force value, so that the second drive is activated according to the sum of the respective second pilot force value and of the respective second setpoint force value.

This embodiment enables the dynamics to be improved in the positioning of the machine element, in particular with changes to the setpoint position value—which as a rule are known in advance.

The invention furthermore makes provision for the third determination facility of the closed-loop controller structure with the aid of the respective provisional pilot force value—in addition to the respective second pilot force value—also to determine a respective first pilot force value for the first drive. In this case the third determination facility outputs the respective first pilot force value to a first addition facility, which adds the respective first pilot force value to the respective first setpoint force value, so that the first drive is activated according to the sum of the respective first pilot force value and of the respective first setpoint force value.

This enables the dynamics achieved by the first drive to be improved during positioning of the machine element, so that the resulting load on the second drive is reduced.

The invention makes provision for the axis inertia of the axis concerned to be taken into account in the determination of the pilot force value, the determination of the pilot force value thus being undertaken as a function of the respective axis inertia.

The overall inertia (also referred to as overall axis inertia or axis inertia for short) J_{Mot} can be determined from the point view of each axis from a model of the machine, as a function of the pose and the loading at each point in time. It should be highlighted here in particular that the determination of the axis inertias is undertaken dynamically during the movement of the system (of the machine), in particular in a clock pulse of the closed-loop controller structure.

In general the so-called axis inertia J_{Mot} is the (overall) inertia of all components moved by the drive (including the inertia of the drive itself). It results from the sum of the inertias of the individual moved components of the machine (related to the axis) and can thus as a rule be obtained from data of the manufacturer of the machine or of the robot.

The axis inertia J_{Mot} includes—as well as the movable parts of the drive itself—all elements of the machine that are moved by the drive, i.e. follow on in the kinematic chain from the drive concerned. For these elements there are as a rule specifications about the moment of inertia or specifications from which the moment of inertia can be determined (geometrical dimensions, mass, center of gravity etc.) on the part of the machine manufacturer.

The invention is based on an axis with a drive unit, which comprises two drives, wherein the first drive (geared motor) acts on the machine element via a transmission facility (gearing) and the second drive (direct drive, torque motor) acts on the machine element directly.

The invention is furthermore based on a drive model, in which the rigidity of the drive train, in particular of the transmission, is modeled by a spring with a specific spring rigidity.

The axis inertia J_{Mot} is now divided into a first axis inertia J_{Mot,an} related to the transmission drive side of the drive unit, and a second axis inertia J_{Mot,ab} related to the transmission take-off side of the drive train.

In accordance with the invention, a third determination facility of the closed-loop controller structure comprises a first inertia determination facility, which determines for the axis concerned the first axis inertia J_{Mot,an} in relation to the transmission drive side of the drive unit. J_{Mot,an} essentially comprises at least the inertias of the first drive (of the transmission motor) and the transmission facility (of the transmission) and also where necessary further components such as a preliminary transmission stage.

The third determination facility furthermore comprises a second inertia determination facility, which determines for the axis concerned, the second axis inertia J_{Mot,ab} related to the transmission take-off side of the drive unit. J_{Mot,ab} comprises the inertia of the second drive (torque motor) and the “load”, wherein the load comprises all mechanical components that are connected along the kinematic chain of the machine to the second drive, i.e. are moved by said drive.

The following relationship applies:

J_{Mot}=J_{Mot,an}+J_{Mot,ab}/i²

wherein i is the transmission ratio of the transmission.

Advantageously the first axis inertia (J_{Mot,an}) and/or the second axis inertia (J_{Mot,ab}) are each included in a different, in particular adjustable weighting, in the determination of the first pilot force value (F1V) and of the second pilot force value (F2V).

In particular at least one of the two pilot force values F1V, F2V depends on both the first and also the second axis inertia.

Advantageously, according to the invention, the respective second pilot force value (F2V) is determined with the aid of the second axis inertia J_{Mot,ab} and a second scaling factor and the respective first pilot force value with the aid of the first axis inertia J_{Mot,an}, of the second axis inertia J_{Mot,ab} and of a first scaling factor.

In a preferred embodiment of the closed-loop controller structure there is provision for the first determination facility furthermore to accept a respective pilot speed control value and for the respective resulting setpoint speed value to be determined as the sum of the respective setpoint speed value and of the respective pilot speed control value. This embodiment enables the dynamics for the positioning of the machine element to be improved even further.

The so-called intalk effect results from the low-pass effect of the drive train. So that a movement of the motor is transmitted through to the load, first of all—in the mass spring model of the drive train—the “drive train spring” must be tensioned. With this just enough torque is stored in the spring in order set the load inertia in motion. The time in which the spring is extended can be shortened with the aid of a compensation movement of the motor. This movement is proportional to the acceleration, load inertia and spring rigidity. This so-called “intalk compensation” as a rule has a strong high-pass character and causes hard force peaks in the mechanical system. In order to smooth out these peaks the compensation can be routed through a low-pass filter for example.

In a preferred embodiment of the closed-loop controller structure there is provision that, for compensation of the intalk effect, a first Intalk compensation determination facility is provided, which accepts the pilot speed control value and determines a compensated pilot speed control value. This is advantageously where necessary multiplied by the transmission ratio before the value determined in this way is likewise supplied to the closed-loop speed controller.

In a further preferred embodiment of the closed-loop controller structure there is provision that, for compensation for the intalk effect, a second intalk compensation determination facility is further provided, which accepts the output value of the third adjustment block and—if necessary after a multiplication by the transmission ratio—determines a compensated first pilot force value.

According to another aspect of the invention, an open-loop control facility controlling the first drive and the second drive includes the aforedescribed closed-loop controller structure

According to yet another aspect of the invention, a machine is controlled by the aforedescribed open-loop control facility.

In a preferred embodiment of the machine, the machine is embodied as a machine tool, as a production machine or as a robot.

According to yet another aspect of the invention, a method of the type mentioned in the introduction includes determining inertia for a first axis and for a second axis, wherein the first axis inertia and/or the second axis inertia are each included in a different, in particular adjustable, weighting in the determination of the first pilot force value and of the second pilot force value.

In particular a method of the type mentioned in the introduction provides, in accordance with the invention, for the first determination facility to accept the respective setpoint speed value and to determine the resulting setpoint speed value using the respective setpoint speed value,
wherein the first determination facility additionally outputs the respective resulting setpoint speed value also to the first closed-loop speed controller and to the second closed-loop speed controller,
wherein the third determination facility, with the aid of the respective provisional pilot force value, determines a respective first pilot force value for the first drive and outputs the respective first pilot force value to a first addition facility, which adds the respective first pilot force value to the respective first setpoint force value, so that the first drive is activated according to the sum of the respective first pilot force value and the respective first setpoint force value,
wherein the respective first pilot force value is determined with the aid of the first axis inertia, the second axis inertia and a first scaling factor and
wherein the respective second pilot force value is determined with the aid of the second axis inertia and a second scaling factor.

### BRIEF DESCRIPTION OF THE DRAWING

Other features and advantages of the present invention will be more readily apparent upon reading the following description of currently preferred exemplified embodiments of the invention with reference to the accompanying drawing, in which:

FIG. 1 shows an example of a machine,

FIG. 2 shows a closed-loop controller structure with control in accordance with the prior art,

FIG. 3 shows a closed-loop controller structure with control according to the invention,

FIG. 4 shows a possible embodiment of the closed-loop controller structure in accordance with FIG. 3,

FIGS. 5-6 show the position behavior as a function of a scaling factor α,

FIGS. 7-8 show the position behavior as a function of a scaling factor α and a restricted torque,

FIG. 9 shows a closed-loop controller structure with intalk compensation,

FIG. 10 shows an intalk effect,

FIG. 11 shows a possible form of embodiment of an intalk compensation determination facility, and

FIG. 12 shows the positioning behavior with intalk compensation,

FIG. 13 shows the torque curve with intalk compensation.

### DETAILED DESCRIPTION OF PREFERRED EMBODIMENTS

Throughout all the figures, same or corresponding elements may generally be indicated by same reference numerals. These depicted embodiments are to be understood as illustrative of the invention and not as limiting in any way. It should also be understood that the figures are not necessarily to scale and that the embodiments are sometimes illustrated by graphic symbols, phantom lines, diagrammatic representations and fragmentary views. In certain instances, details which are not necessary for an understanding of the present invention or which render other details difficult to perceive may have been omitted.

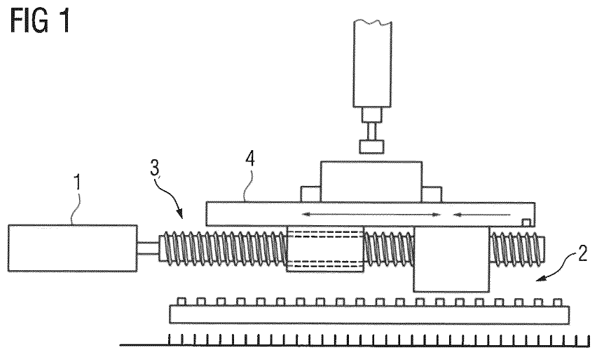

Turning now to FIGS. 1 to 3, a machine has a machine element 4. The machine element 4 can for example be a workpiece table, as depicted in the diagram in FIG. 1. In this case the machine can be embodied as a machine tool for example. As an alternative the machine element 4 can for example involve a gripper arm. In this case the machine can be embodied for example as a production machine. As an alternative the machine element 4 can involve a part of a robot, for example an arm element of a robot gripper arm. According to the diagram in FIG. 1 the machine element 4 is able to be moved translationally. The machine element 4 could however also be able to be turned or pivoted rotationally in relation to a round axis (axis of rotation).

The machine element 4 is moved via a first drive 1 in relation to a first axis. The first drive 1 acts on the machine element 4 via a transmission facility 3. The transmission facility 3 can be embodied as a transmission, as a lead screw or as a ball screw drive. Other embodiments are also possible. A transmission ratio i of the transmission facility 3 can be constant or can depend on an actual position value x of the machine element 4. According to the diagram in FIG. 1 the first drive 1 can be embodied as a rotational drive. If in this case the first drive 1 is rotated by an given angle, for example by 360°, the machine element 4, in the case of a translational movement of the machine element 4 is moved by a distance that is determined by the ratio i of the transmission facility 3, for example by the rise of a lead screw or a ball screw drive. Even if the machine element 4 is likewise rotated with a rotation of the first drive 1, with a rotation of the first drive 1 by a specific angle of rotation, for example 20°, does the angle of rotation by which the machine element 4 is turned only in exceptional cases—namely for a transmission ratio i of 1—match the angle of rotation by which the machine element is turned. As a rule the machine element 1 is rotated by another angle of rotation, for example with a transmission ratio i of 2.5 by 50°. In rare exceptional cases the first drive 1 can also be embodied as a linear drive. In this case too it acts via the transmission facility 3 on the machine element 4 however.

The machine element 4 is furthermore moved via a second drive 2 likewise in relation to the first axis. The second drive 2 acts directly on the machine element 4. “Directly” means that the second drive 2 acts without an intermediate transmission facility on the machine element 4. The second drive 2 can for example be embodied according to the diagram in FIG. 1 as a linear drive, i.e. as a drive that moves translationally. When in this case the second drive 2 is moved by a given distance, for example by 10 mm, the machine element 4 is also moved by precisely the same distance, i.e. by 10 mm in accordance with the example given.

The second drive 2 can however be embodied in other embodiments of the present invention as a rotational drive, in particular as a so-called torque motor. If, with an embodiment as a rotational drive, the second drive 2 is rotated by a given angle, for example by 20°, the machine element 4 will also be rotated by precisely the same angle in relation to the axis of rotation, i.e. by 20° in accordance with the example given.

The first machine element 4 involves the component of the machine that is driven directly by means of the drive unit, which comprises the first and the second drive, in relation to the axis concerned. However, as well as the first machine element 4, all further machine elements, which follow the first machine element 4 from the point of view of the drive unit concerned in the kinematic chain of the machine and are connected directly or indirectly to the first machine element 4, are likewise moved as well by the movement of the first machine element 4.

If for example in a robot, a first arm element of the robot arm is moved in relation to a fixed base about a first (round) axis by a first drive unit, which comprises a first and a second drive, in this way, as well as the first arm element (which in this case corresponds to the first machine element 4), all further components (machine elements following the first arm element in the kinematic chain of the robot arm, such as further arm elements and drives, right through to the end effector, are pivoted about precisely this first axis. From the point of view of the drive unit concerned these components in sum involve the “load” moved by the drive unit.

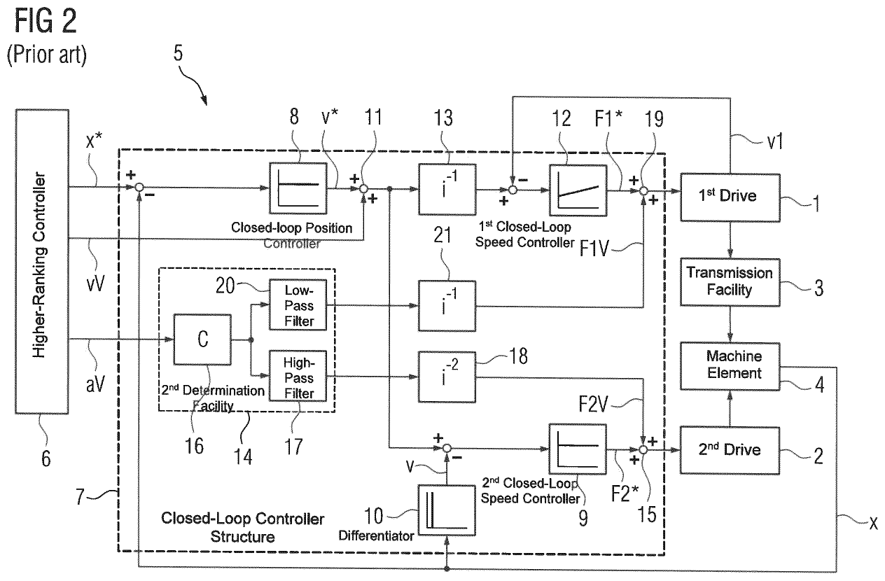

The first drive 1 and the second drive 2 are controlled by an open-loop control facility 5. In accordance with FIG. 2 the open-loop control facility 5 comprises a higher-ranking controller 6 and a closed-loop controller structure 7. The higher-ranking controller 6 can be embodied for example as a numerical control, as a robot controller or as an MC (motion control) control. The embodiment of the closed-loop controller structure 7 is the core subject matter of the present invention.

FIG. 2 shows a prior art embodiment of a closed-loop controller structure 7 with a closed-loop position controller 8. The closed-loop position controller 8 can be embodied, as depicted in the diagram in FIG. 2, in particular as a P controller, i.e. as a proportional controller. The closed-loop position controller 8 accepts from the higher-ranking controller 6 a setpoint position value x*. The closed-loop position controller 8 furthermore accepts from a measuring facility (not shown in FIG. 2) an actual position value x of the machine element 4. The acceptance of the setpoint position value x* and of the actual position value x is undertaken with a closed-loop control clock pulse. With each closed-loop control clock pulse the closed-loop position controller 8 thus accepts a new setpoint position value x* and a new actual position value x of the machine element 4. The closed-loop control clock pulse lies mostly in the range of around 1 ms or somewhat below, for example at 250 μs, 500 μs, 1 ms or 2 ms.

The closed-loop position controller 8 determines with the aid of the respective setpoint position value x* and of the respective actual position value x—in particular with the aid of the difference between respective setpoint position value x* and respective actual position value x—a setpoint speed value v* for the machine element 4 in each case. The term “with the aid of” is intended to mean that the variables mentioned in connection with the term “with the aid of” are all variables that are included in the determination of the stated variable determined in each case. Thus, in a concrete example I, the respective setpoint speed value v*, although dependent on the respective setpoint position value x* and the respective actual position value x, is not however dependent on other variable values. The term “with the aid of” is thus opposite of the terms “as a function of” and “using”. These terms are intended to mean that the variable determined in each case, although it is dependent of said input variables in each case, it is not excluded that dependencies on other variable values also exist. The closed-loop position controller 8, with the closed-loop control clock pulse, outputs the respective setpoint speed value v* determined in each case.

In accordance with FIG. 2 the closed-loop controller structure 7 furthermore comprises a second closed-loop speed controller 9. The second closed-loop speed controller 9 can for example as depicted in the diagram in FIG. 2, be embodied as a P controller. The second closed-loop speed controller 9 accepts with a second closed-loop speed control clock pulse the difference between a resulting setpoint speed value and an actual speed value v of the machine element 4 in each case. The determination of the resulting setpoint speed value and of the actual speed value v is undertaken with a second closed-loop speed control clock pulse. With each such clock pulse the second closed-loop speed controller 9 thus accepts a difference between a new resulting setpoint speed value and a new actual speed value v of the machine element 4. The second closed-loop speed control clock pulse (in respect of time) is at most as large as the closed-loop control clock pulse. It can however also have a smaller value, for example be half as large as the closed-loop control clock pulse.

With the aid of the difference between the respective resulting setpoint speed value and of the respective actual speed value v of the machine element 4, the second closed-loop speed controller 9 determines with the second closed-loop speed control clock pulse a respective second setpoint force value F2* for the second drive 2. The second closed-loop speed controller 9 activates the second drive 2 as a function of the second setpoint force value F2* determined in each case.

For determination of the respective actual speed value v of the machine element 1 the closed-loop controller structure 7 can for example comprise a differentiator 10, to which the respective actual position value x of the machine element 4 is supplied and which, through differentiation of the respective actual position value x of the machine element 4, determines the respective actual speed value v of the machine element 4. As an alternative the respective actual speed value v of the machine element 4 can be determined in another way or acquired directly by measurement technology.

For determination of the respective resulting setpoint speed value, the closed-loop controller structure 7 has a first determination facility 11. The first determination facility 11 accepts the respective setpoint speed value v* from the closed-loop position controller 8 and determines the respective resulting setpoint speed value using the respective setpoint speed value v*. The first determination facility 11 outputs the respective resulting setpoint speed value to the second closed-loop speed controller 9. The first determination facility 11 works with the closed-loop control clock pulse, the first closed-loop speed control clock pulse or a second closed-loop speed control clock pulse, which will be discussed in greater detail below.

The closed-loop controller structure 7 furthermore comprises a first closed-loop speed controller 12. The first closed-loop speed controller 12 can for example, as depicted in the diagram in FIG. 2, be embodied as a PI controller. i.e. as a proportional-integral controller. The first determination facility 11 not only outputs the respective resulting setpoint speed value to the second closed-loop speed controller 9, but also to the first closed-loop speed controller 12. Where necessary the transmission ratio i of the transmission facility 3 is taken into account in a first adaptation block 13. The first closed-loop speed controller 12 accepts the difference between a resulting setpoint speed value and an actual speed value v1 of the first drive 1 with the first closed-loop speed control clock pulse in each case. The first closed-loop speed control clock pulse (in respect of time) is at most as large as the closed-loop control clock pulse. It can however also have a smaller value, for example be half as large as the closed-loop control clock pulse. As a rule it is the same as the second closed-loop speed control clock pulse. The respective actual speed value v1 of the first drive 1 can differ from the respective actual speed value v of the machine element 4, because the acquisition point for the actual speed value v1 of the first drive 1 and the actual speed value v of the machine element 4, as depicted in the diagram in FIG. 2, are located at different ends of the transmission facility 3.

The first closed-loop speed controller 12 determines, with the aid (of the difference) between the respective resulting setpoint speed values and the respective actual speed value v1 of the first drive 1, a respective first setpoint force value F1* for the first drive 1 with the first closed-loop speed control clock pulse. The first closed-loop speed controller 12 activates the first drive 1 as a function of the first setpoint force value F1* determined in each case. The closed-loop position controller 8 also activates the first drive 1 indirectly as a function of the respective setpoint position value x* and the respective actual position value x.

In an embodiment of the closed-loop controller structure 7 in accordance with FIG. 2 the first determination facility 11 can also be “degenerate”. In this case the respective resulting setpoint speed value is identical to the respective setpoint speed value v*. Preferably the first determination facility 11 however, as depicted in the diagram in FIG. 2, also accepts with its working clock pulse a respective pilot speed control value vV. The working clock pulse can involve the closed-loop control clock pulse or one of the closed-loop speed control clock pulses. The respective pilot speed control value vV is specified to the first determination facility 11 by the higher-ranking controller 6. The first determination facility 11 determines the respective resulting setpoint speed value as the sum of the respective setpoint speed value v* and of the respective pilot speed control value vV determined by the closed-loop position controller.

As can be seen from FIG. 2 the closed-loop controller structure 7 has a second determination facility 14. This accepts an acceleration pilot control value aV in each case from the higher-ranking controller 6 with a pilot control clock pulse. The pilot control clock pulse can match the closed-loop control clock pulse or one of the closed-loop speed control clock pulses. As an alternative however the pilot control clock pulse can also have a smaller value, for example be half as large as the second closed-loop speed control clock pulse.

The second determination facility 14 determines with the aid of the respective acceleration pilot control value aV at least one second pilot force value F2V for the second drive 2. The second determination facility 14 outputs the respective second pilot force value F2V to a second addition facility 15. The second addition facility 15 adds the respective second pilot force value F2V to the respective second setpoint force value F2*. The second drive 2 is thus activated according to the sum of the respective second pilot force value F2V and the second setpoint force value F2*.

The second determination facility 14 furthermore has an adaptation facility 16, which converts the respective acceleration pilot control value aV into a provisional pilot force value. The adaptation facility 16 takes into account the mass or the inertia of the machine element 4. In the simplest case the function of the adaptation facility 16 is merely a scaling with a suitably chosen constant C.

The second determination facility 14 then determines the respective second pilot force value F2V with the aid of the respective provisional pilot force value. In particular it is possible for the second determination facility 14 to implement a high-pass filter 17, by means of which the second determination facility 14 determines the respective second pilot force value F2V by high-pass filtering of the respective provisional pilot force value. Where necessary the transmission ratio i of the transmission facility 3 can be taken into account in a second adaptation block 18.

In addition the second determination facility 14 determines a respective first pilot force value F1V for the first drive 1 with the aid of the respective provisional pilot force value. To this end the second determination facility 14 outputs the respective first pilot force value F1V to a first addition facility 19. The first addition facility 19 forms the sum of the respective first pilot force value F1V and the respective first setpoint force value F1*. The first drive 1 is thus activated according to said sum.

It is possible for the respective first pilot force value F1V to match the respective provisional pilot force value. Advantageously, however, the second determination facility 14 comprises a low-pass filter 20. Thus the second determination facility 14 determines the respective first pilot force value F1V by low-pass filtering of the respective provisional pilot force value. Furthermore—similarly to the determination of the respective second pilot force values F2V—for the determination of the respective first pilot force value F1V too, in a third adaptation block 21 the transmission ratio i of the transmission facility 3 is taken into account.

A particular feature of the known closed-loop controller structure is the pilot control of the acceleration, which provides a dynamic division by means of low-pass and high-pass filters for geared motor and torque motor in each case. This method however offers little freedom in the dimensioning of the torque motor. Because the torque motor proportionately must convert the largest torque, as a rule it is the limiting element for the axis acceleration. In order to be able to drive the same acceleration as with the reduction geared motor, the torque motor would have to be dimensioned much larger. Frequently however this is not possible with the space available.

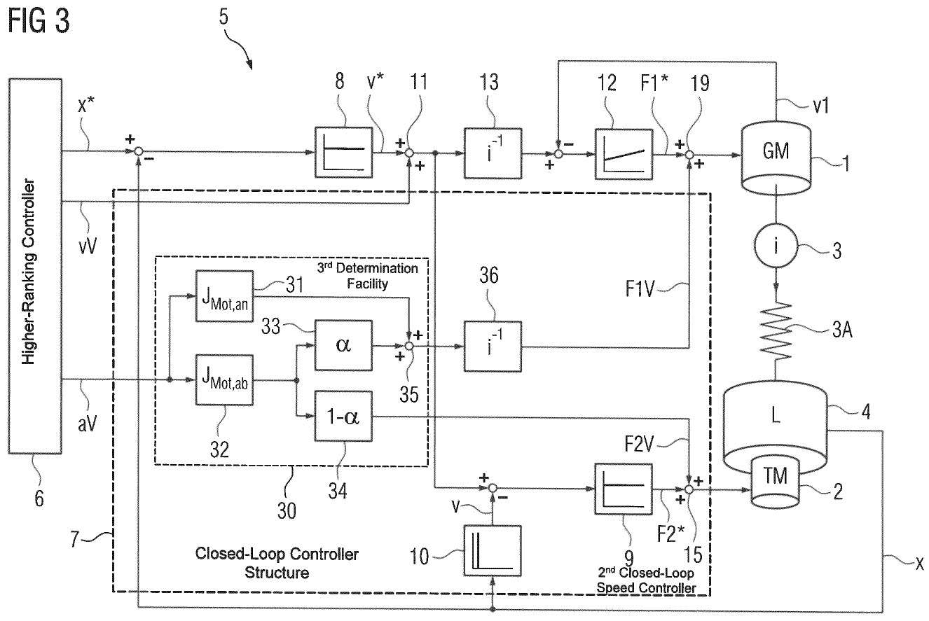

FIG. 3 shows a closed-loop controller structure with control according to the invention. In contrast to FIG. 2, here the components 1 to 4 are shown somewhat differently, namely in a usual model diagram. The first drive 1 is also labeled “GM” (geared motor), the second drive 2 is labeled “TM” (torque motor) and the machine element 4 is labeled “L” (load). The transmission facility 3 (also labeled “i” for the value of the transmission ratio) is now divided to the model components 3 and 3A, wherein the component 3A is shown as a spring and in the model the finite rigidity of the drive train, in particular of the transmission 3, is symbolized.

In contrast to the known closed-loop controller structure in accordance with FIG. 2, the inventive closed-loop controller structure in accordance with FIG. 3 has a third determination facility 30, which accepts an acceleration pilot control value aV in each case with a pilot control clock pulse, determines with the aid of the respective acceleration pilot control value aV a respective second pilot force value F2V for the second drive 2 and outputs the respective second pilot force value F2V to the second addition facility 15, which adds the respective second pilot force value F2V to the respective second setpoint force value F2*, so that the second drive 2 is activated according to the sum of the respective second pilot force value F2V and of the respective second setpoint force value F2*.

The third determination facility 30 furthermore determines with the aid of the respective provisional pilot force value a respective first pilot force value F1V for the first drive 3 and outputs the respective first pilot force value F1V to a first addition facility 19, which adds the respective first pilot force value F1V to the respective first setpoint force value F1*, so that the first drive 1 is activated according to the sum of the respective first pilot force value F1V and the respective first setpoint force value F1*.

The third determination facility 30 furthermore comprises a first inertia determination facility 31, which determines a first axis inertia J_{Mot,an} related to the transmission drive side of the drive train.

The third determination facility 30 furthermore comprises a second inertia determination facility 32, which determines a second axis inertia J_{Mot,ab} related to the transmission take-off side of the drive train.

In this case the respective second pilot force value F2V determines with the aid of the second axis inertia J_{Mot,ab} and a second scaling factor (1-α) and the respective first pilot force value F1V with the aid of the first axis inertia J_{Mot,an}, of the second axis inertia J_{Mot,ab} and a first scaling factor α.

In general Jₘₒₜ describes the overall inertia from the point of view of the axis.

The first axis inertia J_{Mot,an} comprises the inertias of the geared motor 1 of the transmission 3 and possibly of further transmission stages (preliminary gear stage, belt, etc.).

J_{Mot,an} is also the inertia that remains from the point of view of the geared motor 1 after the load has dynamically decoupled.

The second axis inertia J_{Mot,ab} comprises the inertias of the torque motor 2 and of the “load”. In this context “load” is to be understood as the inertia that acts on the drive unit via which the machine element 4 driven by the drive unit acts. It is made up of all inertias of the kinematic chain considered, with the exception of the first axis inertia J_{Mot,an}. Accordingly it comprises the inertia of the machine element 4 and of all subsequent, directly or indirectly connected machine elements along the kinematic chain from the point of view of the drive unit, in short the “load”.

Instead of a complex division according to frequency ranges in accordance with the form of embodiment according to FIG. 2, according to the invention the torque for the acceleration of the load is divided up by means of the scaling factors α1, α2 between the drives, in particular a torque motor and a geared motor. The value of the scaling factors in such cases offers a degree of freedom, whereby the dynamics of the axis and the size of the direct drives (torque motors) can be scaled.

In particular the relationship α1+α2=1 or α2=1−α1 exists between the scaling factors;

Through this relationship only one scaling factor α has to be determined.

The share of the second axis inertia J_{Mot,ab} that is compensated for by the respective motor is chosen with the factor α (or 1−α).

A torque is formed from the setpoint acceleration value, by way of the product with an inertia (J_{Mot,an}, J_{Mot,ab}). Advantageously the torque for the acceleration of the drive train (geared motor and transmission) is assigned to the geared motor and the torque for the acceleration of the load is divided between geared motor and torque motor.

Three cases result from the value of the scaling factor α:
α=0: The torque for the acceleration of the load is assigned to the torque motor alone. This case is the optimal case in respect of the excitation of the eigenfrequency. If the axis is approximated as a two-mass oscillator, each side of the oscillator is activated in the optimal manner and the spring is never deflected. Thus no excitation of the eigenfrequency is produced. The disadvantage however is that this division requires the largest torque motor.
α=1: The torque for the acceleration of the load is assigned to the geared motor. Thus the axis is accelerated by the geared motor alone. The torque motor is only employed for damping. In this case the excitation of the eigenfrequency is maximal, but the size of the torque motor is minimal.
0<α<1: The torque for the acceleration of the load is divided between torque motor and geared motor. The smaller the value of α, the lower is the excitation of the eigenfrequency and the higher are the costs for the torque motor.

In the case of α>0 the eigenfrequency of the axis is always excited and an oscillation occurs. For these cases the damping effect of the P-controlled torque motor is additionally used for oscillation suppression.

Especially advantageously in the inventive solution, the second closed-loop speed controller 9 is designed as a (pure) P controller and thus does not contain any I portion. This means that the second drive (torque motor) 2 does not have to accommodate any holding torque and can thus be dimensioned correspondingly smaller. An active (liquid) cooling for the torque motor can thus be dispensed with as a rule, whereby the space needed for the torque motor can additionally be made smaller.

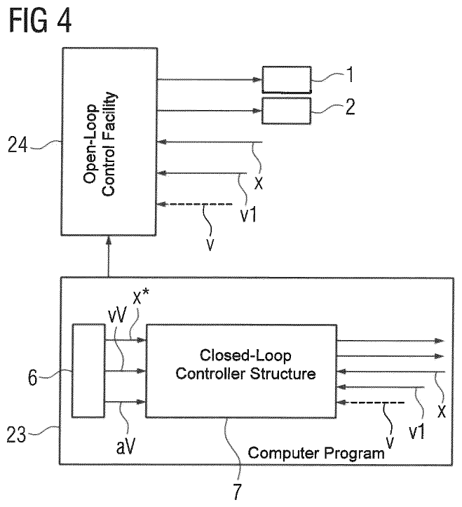

It is possible for the closed-loop controller structure 7 to be constructed in hardware. Preferably however the closed-loop controller structure 7, as depicted in the diagram in FIG. 4, already involves a software block. The software block can in this case be an element of a computer program 23. The computer program 23 in this case comprises machine code, which is able to be executed by an open-loop control facility 24. The open-loop control facility 24 in this case is programmed with the computer program 23. In this case it uniformly realizes both the functionality of the higher-ranking controller 6 and also of the closed-loop controller structure 7.

The closed-loop controller structure 7 thus works with clock pulses, i.e. by accepting its variables with the respective clock pulse. Where further values are specified as variables to the closed-loop controller structure 7 in addition, these variables are also specified to the closed-loop controller structure 7 with their respective clock pulse. In particular the setpoint position value x* and the actual position value and also where necessary the actual speed value v of the machine element 1, the pilot speed control value vV and the acceleration pilot control value aV come into consideration as variables.

The values determined by means of the closed-loop controller structure 7 can also be dependent on parameters however. Parameters are however not variables. Parameters are values that are specified once in advance to the closed-loop controller structure 7 within the framework of its commissioning and that are no longer changed thereafter in ongoing operation. Parameters can for example be proportional amplification factors of the closed-loop position controller 8 and the closed-loop speed controller 9, 12 and an integration time constant of the second closed-loop speed controller 12.

The embodiment of the closed-loop controller structure 7 has been explained above in conjunction with a translationally moved machine element 1, a likewise translationally moved first drive 2 and a rotationally moved second drive 3. The closed-loop controller structure 7 is however likewise able to be realized in an entirely similar way when the machine element 1 is moved rotationally and/or the first drive 2 is moved rotationally and/or the second drive 3 is moved translationally. In this case translational values and corresponding rotational values only have to be used where required, for example setpoint speed values or rotational speed values as required. The structural layout of the closed-loop controller structure 7 is not influenced by this.

Furthermore the present invention has been explained above in conjunction with a higher-ranking controller 6 and an individual closed-loop controller structure 7, wherein an individual machine element 1 is influenced via the closed-loop controller structure 7. The present invention is however just as applicable when a number of machine elements 1 are to be influenced via a first drive 2 and a second drive 3 respectively. In this case the higher-ranking controller 6 can be uniformly present for a number of machine elements 1. The respective closed-loop controller structure 7 is however present individually for the respective machine element 1.

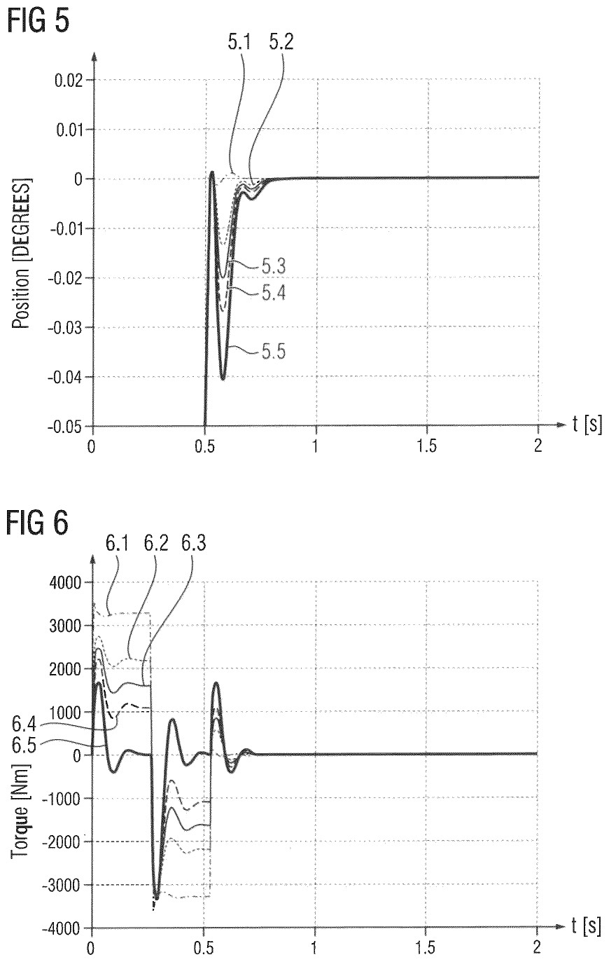

FIG. 5 and FIG. 6 show how, depending on the scaling factor α (alpha), the position behavior worsens as alpha is increased and the average torque of the torque motor reduces as a increases.

In particular FIG. 5 illustrates the positioning for various values of the scaling factor α and FIG. 6 the curve progression of the torque for the torque motor for various values of the scaling factor α over the time t. The visible curves 5.1 and 6.1 show the respective curve progression for α=0, the curves 5.2 and 6.2 show the respective curve progression for α=0.33, the curves 5.3 and 6.3 show the respective curve progression for α=0.5, the curves 5.4 and 6.4 show the respective curve progression for α=0.66 and the curves 5.5 and 6.5 finally show the respective curve progression for α=1.

As illustrated, the positioning accuracy and torque requirement can be advantageously “adjusted” by the factor α.

The extreme case α=1 is considered in more detail below. In this configuration the pilot control torque lies at 100% on the geared motor. There is no pilot control on the torque motor and it serves only as a damper.

In this case the average torque of the torque motor is at its lowest. However, at the beginning of an acceleration phase in each case a torque peak arises, comparable with the height of the torque for other values of α.

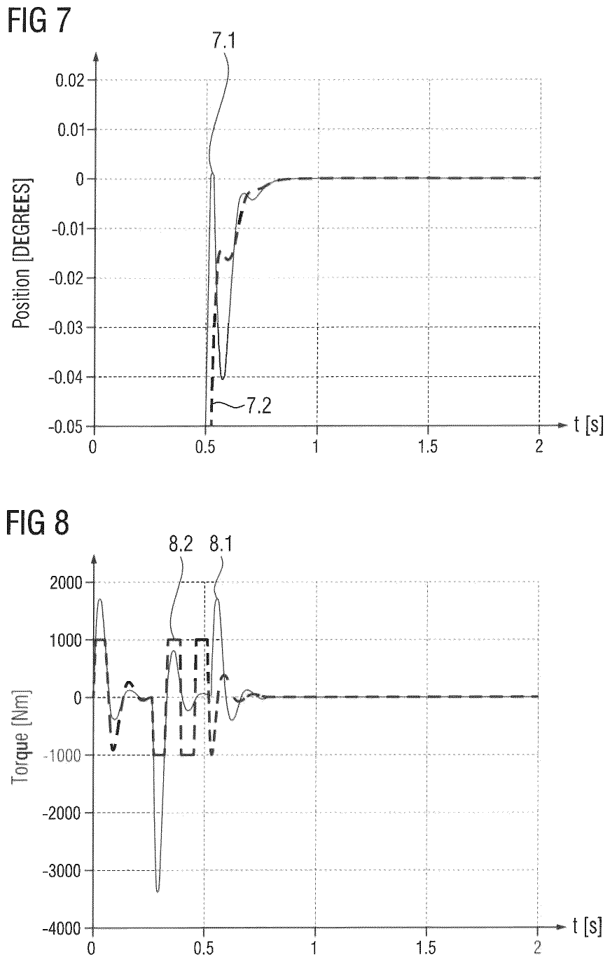

FIGS. 7 and 8 shows that the position behavior does not deteriorate significantly with restricted torque. In particular the curves 7.1 and 8.1 show the position or the torque over the time for α=1 and without restriction of the torque and the curves 7.2 and 8.2 show the position or the torque over the time for α=1 for a restriction of the torque to 1000 Nm.

It can furthermore be analyzed that the undershoots during positioning arise due to the “winding up” of the drive train. During the acceleration phase acceleration forces on the load arise that act against its movement.

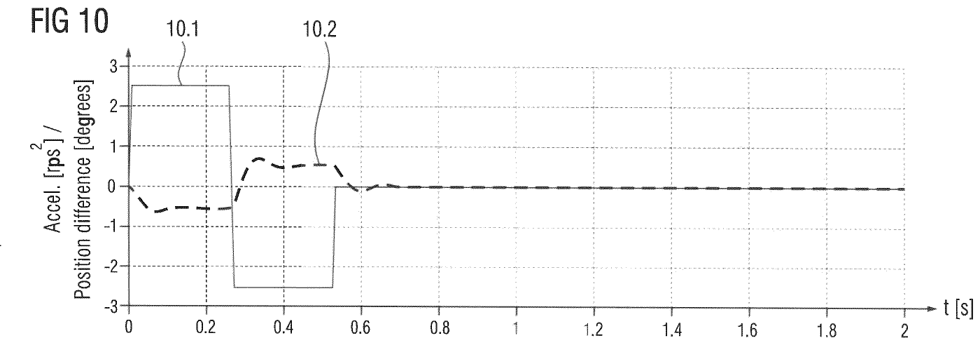

It can be verified that the distance between the measurement system on the geared motor and the measurement system on the load correlates strongly with the acceleration. FIG. 10 illustrates the relationship:

FIG. 10 shows the curve progression of the difference between the measurement systems during the acceleration phase. In particular the curve 10.1 illustrates the acceleration (in revs/s2) and the curve 10.2 the difference between the position delivered by the two measurement systems (position difference) in degrees (°).

The difference in the position delivered by the two measurement systems is also known as the “intalk effect” in the literature.

In order to prevent the undesired deviation on the load, a compensation movement of the geared motor can be pre-controlled. Such “intalk compensation” is implemented in the setpoint value channel. The compensation movement results from the product of the load inertia divided by the rigidity of the drive train. Where necessary, a low-pass filter can ameliorate the strength of the compensation movement somewhat.

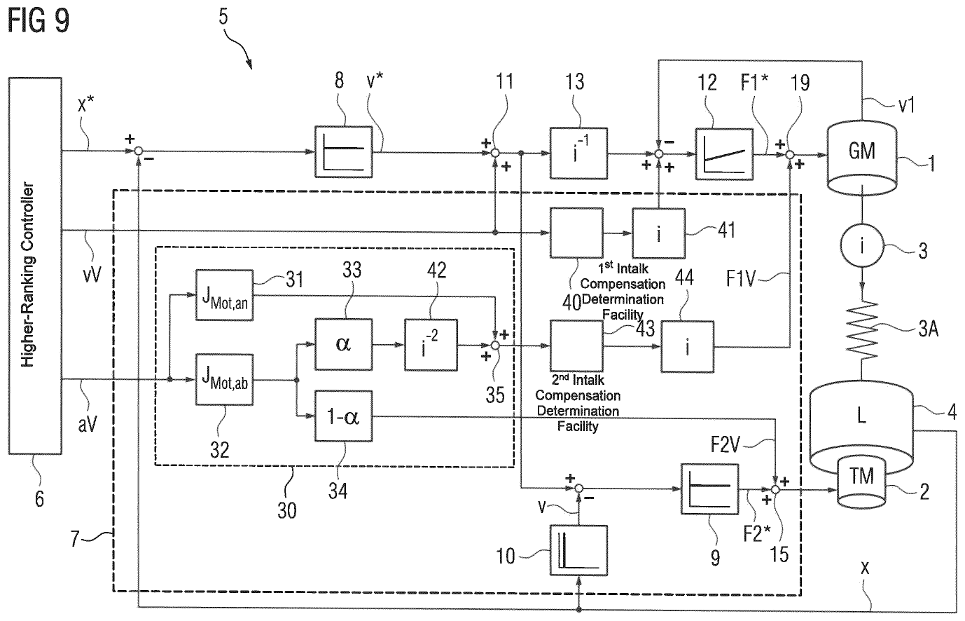

FIG. 9 illustrates a possible adaptation of the closed-loop controller structure in accordance with FIG. 3 to compensate for the intalk effect.

Using the closed-loop controller structure in accordance with FIG. 3 as its starting point, in the form of embodiment in accordance with FIG. 9 there is provision that, to compensate for the intalk effect, a first Intalk compensation determination facility 40 is provided, which accepts the pilot speed control value and determines a compensated pilot speed control value vV*. This is advantageously still multiplied by means of a fourth adaptation block 41 by the transmission ratio i, before the value determined in this way is likewise supplied to the closed-loop speed controller 12.

Furthermore, in the closed-loop controller structure in accordance with FIG. 9, to compensate for the intalk effect, a second intalk compensation determination facility 43 is further provided, which accepts the output value of the third adaptation block 35 and after a multiplication by the transmission ratio i, determines by means of a fifth adaptation block 44 a compensated first pilot force value F1V*.

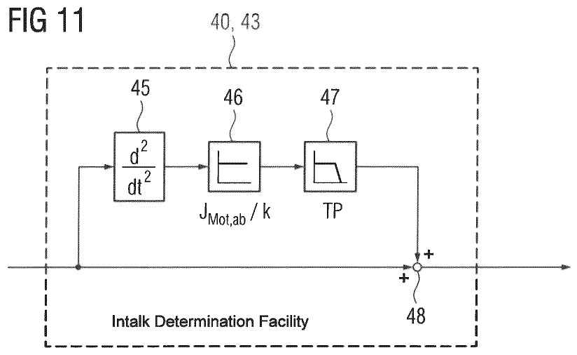

FIG. 11 shows a possible form of embodiment of the intalk compensation determination facility 40 or 43. As can be seen, the input signal is fed into the intalk compensation determination facility once directly and once initially in turn to a two-times differentiator 45, a multiplier 46 with the multiplicator J_{Mot,ab}/k and optionally to a low-pass filter 47 and subsequently to an adder 48. The factor k in this case refers to the spring rigidity of the drive train, in particular of the transmission.

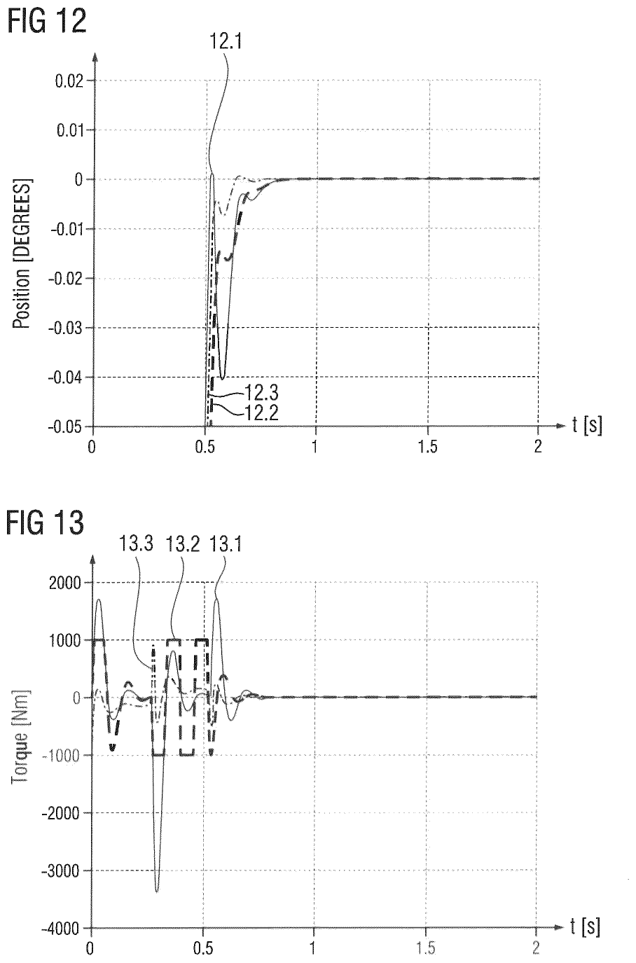

FIG. 12 and FIG. 13 illustrate that the position behavior can be improved by the use of the intalk compensation shown. In this case the torque of the torque motor no longer reaches the previously limiting torque limit.

In particular the FIG. 12 and FIG. 13 illustrate the position behavior and torque curve for α=1 without intalk compensation and without torque limiting (curves 12.1 and 13.1), without intalk compensation and with torque limiting to 1000 Nm (curves 12.2 and 13.2) and also with intalk compensation and with torque limiting to 1000 Nm (curves 12.3 and 13.3)

As illustrated, the intalk compensation advantageously brings about an increase in the positioning accuracy and a reduction in the torque requirement.

A further advantage of this invention is the damping effect (damping) that can be achieved with the torque motor. This damping effect can in particular be achieved by the closed-loop speed controller of the torque motor—as illustrated in FIG. 3—solely having a P element. Since the geared motor looks after the suppression of static forces (process forces, gravitation), the closed-loop speed controller of the torque motor can be set for “optimum damping”.

As an alternative the phases of the torque motor could also be short circuited for damping. The current induced during the relative movement between rotor and stator namely likewise acts as damping torque. Only in this case the resulting damping cannot be adjusted.

A further advantage of this invention results from the fact that, by dispensing with the I portion of the rotational speed controller of the torque motor, no static force is compensated for by the motor and the motor does not have to be permanently powered. Thus, through the invention, a smaller motor can be used compared to a conventional solution. Through this the space needed for the torque motor and the costs for the torque motor can be reduced. Furthermore advantageously with the inventive solution at least an active cooling can be dispensed with for the torque motor. Through the absence of. A cooling unit (fan, liquid cooling), the space on the machine needed for the torque motor can additionally be reduced. Also the integration of the torque motor into the machine is greatly simplified by this and where necessary even the machine as a whole—with the same technical data (maximum speed, acceleration, payload/force at TCP)—can be built smaller.

Furthermore the outlay or the costs for a cooling unit are considerable. By possibly dispensing with the (active) cooling the costs for the motor or the machine as a whole are significantly lowered.

The invention can be used to particular advantage in robots, in which both drives act on a round axis. Thus, especially with robots, an installation dimension that is as small as possible and a weight for the drives that is as small as possible are of particular importance.

In summary a significant advantage of the invention lies in the fact that the dynamics of an axis can be massively increased by the combination of two drives in conjunction with the inventive closed-loop controller structure. The same naturally applies for a machine as a whole, which comprises a number of such axes, in particular in the form of a kinematic chain. Furthermore, through clever activation and compensation, the costs for the take-off side torque motor can be massively reduced. The strong increase in productivity and precision with limited increase in the costs (compared to axes with only one drive) is advantageous above all for the integration into standard 6-axis robots and thus opens up new application fields (lasers, water jet cutting, milling of steel). But this is also of advantage for specific machine tool types.

Especially advantageously, the inventive closed-loop controller structure and/or the higher-ranking controller and/or the machine concerned with a number of machine elements 1, which in particular form a kinematic chain, can also be implemented in the form of a digital twin. Then it is possible to first test entire movement sequences of the machine, in particular under different load conditions, before the real implementation, in a simulation. This is then especially possible merely with slight additional outlay, when the closed-loop controller structure—as already mentioned above—is realized in any event at least largely in the form of software.

In summary the present invention thus relates to the following subject matter:

A first drive 1 acts directly on a machine element 4 of a second drive 2 via a transmission facility 3. A closed-loop position controller 8 accepts a setpoint position value x* and an actual position value x of the machine element 1 and determines with the aid these variables x*, x a setpoint speed value v* for the machine element 4. A first determination facility 11 accepts the setpoint speed value v* and determines a resulting setpoint speed value using the setpoint speed value v*. A second closed-loop speed controller 9 determines a second setpoint force value F2* with the aid of the difference between the resulting setpoint speed value and of the actual speed value v of the machine element 1 and activates the second drive 2 as a function of this setpoint force value F2*. A first closed-loop speed controller 12 determines a first setpoint force value F1* with the aid of the difference between the resulting setpoint speed value and of the actual speed value v of the first drive 1 and activated the first drive 1 as a function of this setpoint force value F1*.

Advantageously a first axis inertia (J_{Mot,an}) and a second axis inertia (J_{Mot,ab}) are determined, which are each included in a different, in particular adjustable, weighting in the determination of the first pilot force value (F1V) and of the second pilot force value (F2V).

The present invention has many advantages. In particular—with the exception of the adaptation of the transmission ratio i of the transmission facility 3—both closed-loop speed controllers 9, 12 operate with the same guide variable. The embodiment of the second closed-loop speed controller 9 as a proportional controller avoids any static force being able to build up for the second drive 2. The damping of vibrations of the machine element 4 is on the other hand not negatively influenced. A P-controller is completely sufficient for this. The inventive solutions are able to be realized robustly and at low cost.

While the invention has been illustrated and described in connection with currently preferred embodiments shown and described in detail, it is not intended to be limited to the details shown since various modifications and structural changes may be made without departing in any way from the spirit and scope of the present invention. The embodiments were chosen and described in order to explain the principles of the invention and practical application to thereby enable a person skilled in the art to best utilize the invention and various embodiments with various modifications as are suited to the particular use contemplated.

What is claimed as new and desired to be protected by Letters Patent is set forth in the appended claims and includes equivalents of the elements recited therein:

What is claimed is:

1. A closed-loop controller structure, comprising:
a first drive controlled by a first pilot force value and acting on a machine element via a transmission facility;
a second drive controlled by a second pilot force value and acting directly on the machine element for movement of the machine element in relation to an axis; and
a third determination facility comprising a first inertia determination facility that determines a first axis inertia and a second inertia determination facility that determines a second axis inertia,
wherein the first axis inertia and the second axis inertia are each applied with different weighting in a determination of the first pilot force value and of the second pilot force value.

2. The closed-loop controller structure of claim 1, wherein the different weighting is adjustable.

3. The closed-loop controller structure of claim 1, further comprising:
a closed-loop position controller, which accepts with a closed-loop control clock pulse a difference between a setpoint position value and an actual position value of the machine element and activates the first drive as a function of the setpoint position value and the actual position value;
a second closed-loop speed controller, which accepts with a first closed-loop speed control clock pulse a difference between a resulting setpoint speed value and an actual speed value of the machine element, determines a second setpoint force value for the second drive with the aid of the resulting setpoint speed value and of the actual speed value of the machine element, and activates the second drive as a function of the second setpoint force value;
a first determination facility, which determines the resulting setpoint speed value and outputs the resulting setpoint speed value to the first closed-loop speed controller,
wherein the closed-loop position controller determines with the aid of the difference between the setpoint position value and the actual position value a setpoint speed value for the machine element and outputs the setpoint speed value as an output signal,
the closed-loop controller structure further comprising a first closed-loop speed controller, which accepts with a first closed-loop speed control clock pulse the difference between the resulting setpoint speed value and an actual speed value of the first drive, and determines a first setpoint force value for the first drive with the aid of the difference between the resulting setpoint speed value and the actual speed value of the first drive, and activates the first drive as a function of the respective first setpoint force value,
wherein the first determination facility accepts the setpoint speed value and determines the resulting setpoint speed value using the setpoint speed value, and outputs the resulting setpoint speed value to the second closed-loop speed controller in addition to the first closed-loop speed controller,
the closed-loop controller structure further comprising a third determination facility, which accepts with a pilot control clock pulse an acceleration pilot control value, determines with the aid of the acceleration pilot control value a second pilot force value for the second drive and outputs the second pilot force value to a second addition facility, with the second addition facility adding the second pilot force value to the second setpoint force value, so that the second drive is activated according to the sum of the second pilot force value and the respective second setpoint force value,
wherein the third determination facility determines with the aid of the provisional pilot force value a respective first pilot force value for the first drive and outputs the first pilot force value to a first addition facility, which adds the first pilot force value to the respective first setpoint force value, so that the first drive is activated according to the sum of the first pilot force value and the first setpoint force value,
wherein the first pilot force value is determined based on the first axis inertia, the second axis inertia and a first scaling factor, and
wherein the second pilot force value is determined based on the second axis inertia and a second scaling factor.

4. The closed-loop controller structure of claim 3, wherein a sum of the first scaling factor and the second scaling factor is equal to 1.

5. The closed-loop controller structure of claim 3, wherein the first determination facility accepts a respective pilot speed control value and determines the resulting setpoint speed value as a sum of the setpoint speed value and the pilot speed control value.

6. The closed-loop controller structure of claim 3, further comprising, to compensate for an intalk effect, a first intalk compensation determination facility which accepts the pilot speed control value and determines a compensated pilot speed control value.

7. The closed-loop controller structure of claim 3, further comprising, to compensate for an intalk effect, a second intalk compensation determination facility which determines a compensated first pilot force value.

8. The closed-loop controller structure claim 6, further comprising a fourth adaptation block configured to adapt the compensated pilot speed control value to a transmission ratio.

9. The closed-loop controller structure claim 7, further comprising a fifth adaptation block configured to adapt the compensated first pilot force value to a transmission ratio.

10. The closed-loop controller structure of claim 3, wherein the second closed-loop speed controller is embodied as a P-controller.

11. An open-loop control facility for a first drive acting on a machine element via a transmission facility and a second drive acting directly on the machine element, the open-loop control facility comprising a higher-ranking open-loop controller and a closed-loop controller structure, with the higher-ranking open-loop controller specifying for the closed-loop controller structure with a closed-loop control clock pulse setpoint position values, wherein the closed-loop controller structure is embodied as set forth in claim 1.

12. A machine, comprising:
a machine element;
a transmission facility;
a first drive operating via the transmission facility on the machine element; and
a second drive operating directly on the machine element,
wherein the first drive and the second drive are controlled by an open-loop control facility as set forth in claim 11.

13. The machine of claim 12, wherein the machine is embodied as a machine tool, as a production machine or as a robot.

14. The machine of claim 12, wherein the second drive lacks a cooling unit for active cooling.

15. A method for closed-loop control of a drive unit having a first drive operating on a machine element via a transmission facility and being controlled by a first pilot force value, and a second drive being controlled by a second pilot force value and operating directly on the machine element for movement of the machine element in relation to an axis, the method comprising:
determining a first axis inertia and a second axis inertia; and
determining the first pilot force value and of the second pilot force value by weighting the first axis inertia and the second axis inertia with different weighting factors.

16. The method of claim 15, comprising:
accepting by a closed-loop position controller with a closed-loop control clock pulse the difference between a setpoint position value and an actual position value of the machine element and activating the first drive as a function of the setpoint position value and the actual position value;
accepting by a second closed-loop speed controller with a first closed-loop speed control clock pulse the difference between a resulting setpoint speed value and an actual speed value of the machine element, determining a second setpoint force value for the second drive with the aid of the resulting setpoint speed value and of the actual speed value of the machine element, and activating the second drive as a function of the second setpoint force value;
determining with a first determination facility the resulting setpoint speed value and outputs the resulting setpoint speed value to the first closed-loop speed controller;
determining by the closed-loop position controller a setpoint speed value for the machine element with the aid of the difference between the setpoint position value and the actual position value and outputting the setpoint speed value as an output signal;
accepting by a first closed-loop speed controller with a first closed-loop speed control clock pulse the difference between the resulting setpoint speed value and an actual speed value of the first drive, determining a first setpoint force value for the first drive with the aid of the difference between the resulting setpoint speed value and the actual speed value of the first drive, and activating the first drive as a function of the first setpoint force value;
accepting by the first determination facility the setpoint speed value and determining the resulting setpoint speed value using the setpoint speed value;
outputting by the first determination facility the resulting setpoint speed value to the second closed-loop speed controller in addition to the first closed-loop speed controller; and
determining by the third determination facility a first pilot force value for the first drive with the aid of the provisional pilot force value and outputting the first pilot force value to a first addition facility, which adds the first pilot force value to the first setpoint force value, so that the first drive is activated according to a sum of the first pilot force value and the first setpoint force value,
wherein the first pilot force value is determined with the aid of the first axis inertia, the second axis inertia and a first scaling factor, and
wherein the second pilot force value is determined with the aid of the second axis inertia and a second scaling factor.

17. The method of claim 16, wherein a sum of the first scaling factor and the second scaling factor is equal to 1.

18. The method of claim 16, wherein the first determination facility accepts a pilot speed control value and determines the resulting setpoint speed value as a sum of the resulting setpoint speed value and the pilot speed control value.

19. The method of claim 15, further comprising, to compensate for an intalk effect, accepting with a first intalk compensation determination facility the pilot speed control value and determining a compensated pilot speed control value.

20. The method of claim 15, further comprising, to compensate for an intalk effect, determining with a second intalk compensation determination facility a compensated first pilot force value.

21. The method of claim 19, further comprising adapting with a fourth adaptation block the compensated pilot speed control value to a transmission ratio.

22. The method of claim 20, further comprising adapting with a fifth adaptation block the compensated first pilot force value to a transmission ratio.
